(19) United States
(12) Patent Application Publication
(10) Pub. No.: US 2014/0257964 A1
(43) Pub. Date: Sep. 11, 2014

(54) SYSTEM AND METHOD FOR POINT-OF-SALE (POS) UNIVERSAL PRODUCT CODE DETECTION, BLOCKING AND INJECTING

(71) Applicant: OUTSITE NETWORKS, INC., Norfolk, VA (US)

(72) Inventors: Anton Bakker, Norfolk, VA (US); Marc L. Allen, Virginia Beach, VA (US)

(73) Assignee: Outsite Networks, Inc., Norfolk, VA (US)

(21) Appl. No.: 13/788,252

(22) Filed: Mar. 7, 2013

(51) Int. Cl. G06Q 30/02

(52) U.S. Cl. CPC G06Q 30/0238
USPC 705/14.38

(57) ABSTRACT

A system, method and computer program product for processing promotions, including a universal product code (UPC) injection sub-system coupled between a UPC reader device and a point-of-sale (POS) device. The universal product code (UPC) injection sub-system including an interface device coupled between the UPC reader device and the POS device and incorporating an OR function to prevent disruption of an existing data stream between the POS device and the UPC reader device; and a controller device coupled to the interface device. The controller device via the interface device is configured to detect a UPC transmitted between the UPC reader and the POS device, block a UPC transmitted between the UPC reader and the POS device, and inject a UPC into the POS device. The POS device performs a POS function based on a received UPC from the controller device.

### BACKGROUND OF THE INVENTION

1. Field of the Invention

The present invention generally relates to systems and methods for processing promotions, and more particularly to a system and method for point-of-sale (POS) Universal Product Code (UPC) detection, blocking, injection, and the like.

2. Discussion of the Background

New marketing technologies desire transactional engagement for product discounting at a point-of-sale (POS), for example, including promotions, and the like, based on consumer purchase history, geographical locations, time of day promotions, special, discount items, and the like. However, the current systems and methods have various problems with respect to interfacing with legacy POS installations, and the like.

### SUMMARY OF THE INVENTION

Therefore, there is a need for a method and system that addresses the above and other problems with conventional systems and methods. The above and other problems are addressed by the illustrative embodiments of the present invention, which provide a novel system and method for point-of-sale (POS) Universal Product Code (UPC) detection, blocking, injection, and the like.

A system, method and computer program product for processing promotions, including a universal product code (UPC) injection sub-system coupled between a UPC reader device and a point-of-sale (POS) device. The universal product code (UPC) injection sub-system including an interface device coupled between the UPC reader device and the POS device and incorporating an OR function to prevent disruption of an existing data stream between the POS device and the UPC reader device; and a controller device coupled to the interface device. The controller device via the interface device is configured to detect a UPC transmitted between the UPC reader and the POS device, block a UPC transmitted between the UPC reader and the POS device, and inject a UPC into the POS device. The POS device performs a POS function based on a received UPC from the controller device.

The POS function includes reducing a transaction amount by a negative dollar amount associated with a UPC received from the controller device.

The POS function includes issuing a reward based on a UPC received from the controller device.

The POS function includes issuing an incentive based on a UPC received from the controller device.

The UPC can include a bar code.

Still other aspects, features, and advantages of the present invention are readily apparent from the following detailed description, by illustrating a number of illustrative embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 shows an illustrative system and method for point-of-sale (POS) Universal Product Code (UPC) detection, blocking, injection, and the like;

FIG. 2 shows an illustrative flow chart corresponding to the system and method of FIG. 1; and

FIG. 3 shows an illustrative system and method for point-of-sale (POS) Universal Product Code (UPC) detection, blocking, injection, and the like.

### DETAILED DESCRIPTION OF THE PREFERRED EMBODIMENTS

The present invention includes recognition that new marketing technologies desire transactional engagement for product discounting at a point-of-sale (POS), for example, including promotions, and the like, based on consumer purchase history, geographical locations, time of day promotions, special, discount items, and the like. The present invention further includes recognition that the current systems and methods have various problems with respect to interfacing with legacy POS installations, and the like. The present invention further includes recognition that legacy POS installations provide numerous hurdles for transaction engagement (e.g., injection of money or discounts via a Universal Product Code (UPC) that represents a negative value in a POS product lookup (PLU) code via a barcode, UPC code, etc.).

Generally, the present invention utilizes an existing UPC input to a POS system for transactional engagement (e.g., as further described in U.S. patent application Ser. No. 12/420,786, incorporated by reference herein). However, disrupting a UPC reader to POS data stream with a computer system (e.g., as described in U.S. Pat. No. 8,275,655) may risk disrupting the UPS/POS operation. Advantageously, the present invention allows for adding (e.g., via an OR function) UPC codes to the existing UPC POS data stream, based on processing the existing UPC/POS data stream without disrupting the existing POS data stream and thus preserving the integrity of the UPC/POS interface. Advantageously, such “ORing” capability allows a Scanner/POS interface to operate even if the added components of the present invention loses power or fails in other ways, and the like.

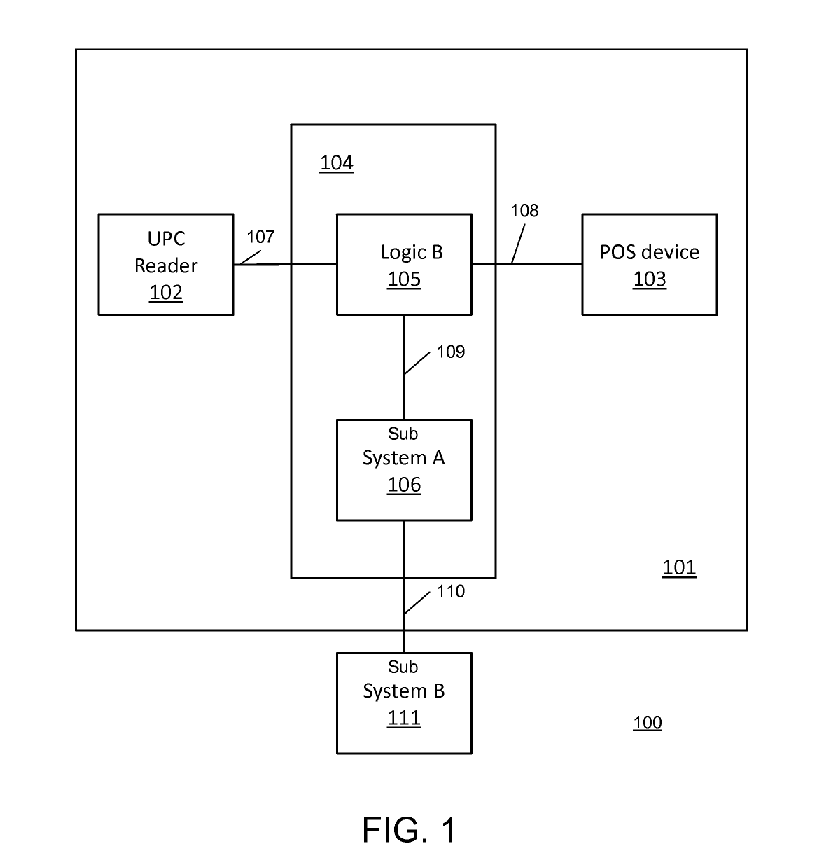

Referring now to the drawings, wherein like reference numerals designate identical or corresponding parts throughout the several views, and more particularly to FIG. 1 thereof, there is shown an illustrative point-of-sale (POS) universal product code (UPC) system and method with detect, block and inject capability, and the like.

In FIG. 1, the point-of-sale (POS) universal product code (UPC) system 100 (e.g., existing device at retail facility, such as a grocery store, convenience store, other store, theatre, gas station, car wash, etc.) with detect, block and inject capability can include a POS UPC subsystem 101. The POS UPC subsystem 101 can include a UPC reader device 102 (e.g., existing device at retail facility), a POS device 103 (e.g., existing device at retail facility), a UPC detect, block, and inject subsystem 104 (e.g., wireless-based devices, wired devices, etc.), suitable logic B 105 (e.g., suitable hardware and/or software), a subsystem A 106 (e.g., suitable hardware and/or software), a UPC reader interface 107 (e.g., suitable hardware and/or software), a POS UPC interface 108 (e.g., suitable hardware and/or software), and logic B and subsystem A interface 109 (e.g., suitable hardware and/or software). A subsystem A to subsystem B interface 110 (e.g., suitable hardware and/or software) is provided for interfacing with a subsystem B 111 (e.g., suitable hardware and/or software).

The system can be configured to maintain a direct UPC reader 102 interface with the POS device 103 via the logic B 105 and the interfaces 107 and 108 without a need for routing the corresponding data through a separate CPU system. The subsystem A 106 is configured to monitor the UPC reader 102 interface 107 with the POS device 103 via the logic B 105 and the interfaces 107 and 108 to determine the UPC codes read by UPC reader 102.

The system can be configured to inject additional UPC's to the POS UPC interface 108 by a logical OR function, and the like, of logic B 105. The additional UPC or UPCs are generated by the subsystem A 106 via the interface 109 and the logic B 105.

The system can be configured to detect a collision of a UPC read with the UPC reader 102 and the UPC generated with the subsystem A 106. The collision is reported to subsystem A 106 via the interface 109, for example, employing an error bit indicator to the I/O of the subsystem A 106. Alternatively, collisions can be detected at the subsystem A 106, for example, by monitoring the input from the UPC reader 102 and comparing such input to the output from the subsystem A 106 to the logic B 105. Advantageously, such an approach can simplify the interface 109 to include an input from UPC reader 102 and an output to the logic B, allowing the subsystem A 106 to handle collision detection, UPC corruption, and the like. Upon collision, the system can be configured to re-transmit the original UPC from the UPC reader 102 that collided with the pseudo UPC generated from the subsystem A via interfaces 108 and 108, as the subsystem A 106 can be aware of the UPCs scanned by UPC reader 102.

In the case of corrupting undesired UPC codes (e.g., blocking UPCs), the subsystem A 106 can be configured to monitor the UPC code from the UPC reader 102 and determine prior to the completion of the multi digit UPC code that the UPC code is to be blocked from successful transmission to the POS 103. The UPCs can be blocked by being identified as UPCs to be blocked in the subsystem A 106. The subsystem A can disrupt the transmission of the UPC code to the POS 103 by corrupting the UPC code with the logic B 105 causing, for example, the UPC check digit to be incorrect or omitting digits from the UPC code, or by buffering UPC codes before committing UPC codes, and the like. However, any other suitable blocking mechanisms can be employed. This can be done, for example, to block discount UPCs to be presented to the UPC reader 102 by the shopper or store personnel, and the like. Attempts can be detected and can result in the subsystem A 106 preventing further discounts due to fraud attempt detection, and the like. This also can be accomplished by transmitting from the subsystem A 106 while the UPC reader 102 is transmitting, which can corrupt the POS 103 UPC data and result in a failed read at the POS 103.

The subsystem A 106 can be configured to connect to additional systems and/or networks or operate in a standalone manner, and the like. The system can be configured to determine disconnecting of the POS 103 or the UPC reader 102, for example, for enabling fraud detection capabilities, and the like. In addition, system disconnect events, and the like, can be reported for fraud management, and the like.

The system can be configured with the capability to inject (e.g., by adding) UPC codes to the POS data stream without such UPCs being detected by the UPC reader 102 and interface 107. Such feature can be used, for example, to inject funds into a POS transaction based on product look up (PLU) codes, and the like. Such funds can be for enabling use of an electronic wallet with an interface to the subsystem A 106 via the interface 111 to the subsystem B 111.

The system can be configured to substitute UPC codes based on blocking UPC codes and adding substitute UPC codes. Substitute UPC codes are desirable for converting UPC codes that are non-readable by the POS 103 into readable POS codes for the POS 103. For example, some legacy POS systems may not be able to read more modem UPC codes, such as GS1 barcodes, and the like. Advantageously, the system will allow for new, more modem or custom UPC codes to be converted into legacy POS system readable codes. Such a feature can be useful for converting serialized UPC codes into non-serialized UPC codes, and the like, while tracking the serial codes in the subsystem A 106.

Thus, the system can be configured to read UPC codes that may not be readable by the POS subsystem 103 and translate them into readable UPC code for the POS subsystem 103. The system also can be configured with the ability to inject UPC codes without requiring any codes to being scanned at the UPC reader 102. This feature can be used to inject monetary credit into the POS subsystem 103 via suitable UPC codes for purchases, for example, that do not require any UPC codes (e.g., coffee, etc.).

The system can be configured for detection of special or predetermined UPC codes, and the like, not intended for the POS 103, but intended for the subsystem A 106. For example, an end of transaction indicator UPC can be generated. With such an end of transaction (e.g., last UPC) indicator UPC, the to be injected UPC codes can be based on logic for excluding UPCs, wherein without such an end of transaction UPC no excluding logic can be used.

The system can be configured for an age verification UPC, wherein the UPC scanner 107 can scan items, such as beer or cigarettes, and the like, that require age verification, and the like, and the system would need to know if the age verification was positive. In this case, a special or predetermined UPC code can be used to communicate such an event to subsystem A 106 with a special or predetermined set of UPC codes, and the like, that can be blocked from the POS 103 and interpreted by the subsystem A 106.

The subsystem A 106 and the logic B 105 can be optionally powered from existing power source of the POS 103 in the cable going to the UPC reader 102. Advantageously, this avoids increasing the risk of integrity of the system by introducing an external power supply. However, when such option is not available, an external power supply can be employed.

In an illustrative embodiment, the logic B 105 can include hardware and/or software devices, programmable logic devices (PLD), optical, digital or analog devices, CPU-based devices, and the like. The interfaces between the various devices and components 101-111 can be serial, USB, Ethernet, RF, Wi-Fi, RS232, RS485, and the like. The CPU based systems can be local or remote, networked, wired and/or wireless, systems, and the like. The subsystems A 106 and B 105 can be implemented inside a barcode reader, wherein such a barcode reader can be configured to create such capability as part of the barcode reader CPU and supporting hardware and/or software and for creating suitable interfaces 109 and 108 to subsystem A 106 and the POS device 103, respectively.

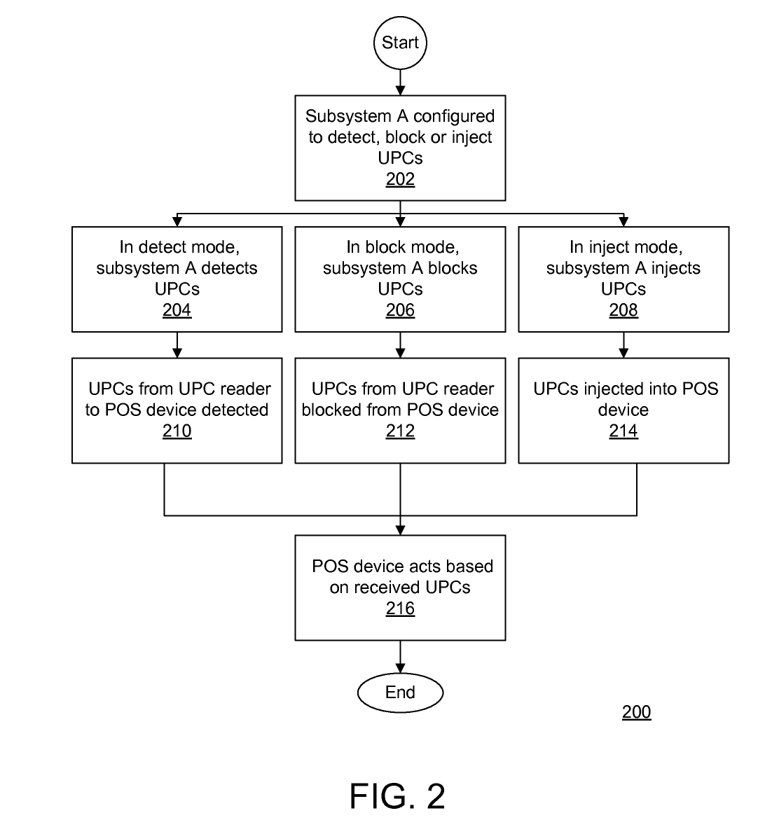

FIG. 2 shows an illustrative flow chart corresponding to the system of FIG. 1. In FIG. 2, at step 202, the UPC unit 104 tracks scanned UPCs and reports the UPC information to the server 105. At step 204, an RFID (or any other suitable consumer ID, etc.) can be associated with the UPC scans. At step 206, transactions having consumer ID and a UPC associated with a reward mechanism are issued a reward to an account associated with the consumer ID. At step 208, when reward is due for issuance, the system 100 can inject a pseudo barcode/UPC into the POS system 101 and reduce the transaction by a negative dollar amount associated with the pseudo barcode/UPC, completing the process. Thus, Subsystem A can be configured to be in one of three states (e.g., Detect, Block, and Inject), wherein Subsystem A can switch between these three states based on predetermined activity (e.g., a UPC being detected, when a UPC is to be injected, when a UPC is to be blocked, etc.).

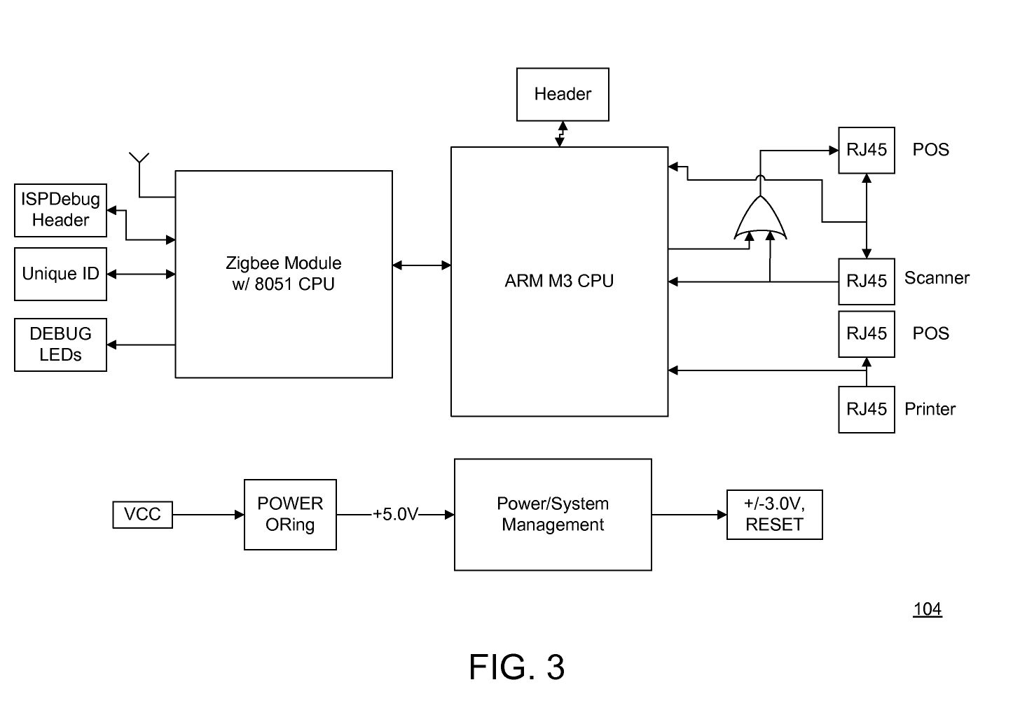

FIG. 3 shows an illustrative system and method for point-of-sale (POS) Universal Product Code (UPC) detection, blocking, injection, and the like. In FIG. 3, the subsystem 104 is shown in more detail, including illustrative hardware and/or software components and/or logic devices.

The above-described devices and subsystems of the illustrative embodiments of FIGS. 1-3 can include, for example, any suitable servers, workstations, PCs, laptop computers, PDAs, Internet appliances, handheld devices, cellular telephones, wireless devices, other devices, and the like, capable of performing the processes of the illustrative embodiments of FIGS. 1-3. The devices and subsystems of the illustrative embodiments of FIGS. 1-3 can communicate with each other using any suitable protocol and can be implemented using one or more programmed computer systems or devices.

One or more interface mechanisms can be used with the illustrative embodiments of FIGS. 1-3, including, for example, Internet access, telecommunications in any suitable form (e.g., voice, modem, and the like), wireless communications media, and the like. For example, the employed communications networks can include one or more wireless communications networks, cellular communications networks, 3G communications networks, Public Switched Telephone Network (PSTNs), Packet Data Networks (PDNs), the Internet, intranets, a combination thereof, and the like. Accordingly, the devices and subsystems of the illustrative embodiments can be implemented on the World Wide Web.

It is to be understood that the devices and subsystems of the illustrative embodiments of FIGS. 1-3 are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments of FIGS. 1-3 can be implemented via one or more programmed computer systems or devices.

To implement such variations as well as other variations, a single computer system can be programmed to perform the special purpose functions of one or more of the devices and subsystems of the illustrative embodiments of FIGS. 1-3. On the other hand, two or more programmed computer systems or devices can be substituted for any one of the devices and subsystems of the illustrative embodiments of FIGS. 1-3. Accordingly, principles and advantages of distributed processing, such as redundancy, replication, and the like, also can be implemented, as desired, to increase the robustness and performance the devices and subsystems of the illustrative embodiments of FIGS. 1-3.

The devices and subsystems of the illustrative embodiments of FIGS. 1-3 can store information relating to various processes described herein. This information can be stored in one or more memories, such as a hard disk, optical disk, magneto-optical disk, RAM, and the like, of the devices and subsystems of the illustrative embodiments of FIGS. 1-3. One or more databases of the devices and subsystems of the illustrative embodiments of FIGS. 1-3 can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments of FIGS. 1-3 can include appropriate data structures for storing data collected and/or generated by the processes of the devices and subsystems of the illustrative embodiments of FIGS. 1-3 in one or more databases thereof.

All or a portion of the devices and subsystems of the illustrative embodiments of FIGS. 1-3 can be conveniently implemented using one or more general purpose computer systems, microprocessors, digital signal processors, micro-controllers, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments of FIGS. 1-3 can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments of FIGS. 1-3, for driving the devices and subsystems of the illustrative embodiments of FIGS. 1-3, for enabling the devices and subsystems of the illustrative embodiments of FIGS. 1-3 to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments of FIGS. 1-3. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments of FIGS. 1-3 can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A computer implemented system for processing promotions, the system comprising:
a universal product code (UPC) injection sub-system coupled between a UPC reader device and a point-of-sale (POS) device;
the universal product code (UPC) injection sub-system including:
an interface device coupled between the UPC reader device and the POS device and incorporating an OR function to prevent disruption of an existing data stream between the POS device and the UPC reader device; and
a controller device coupled to the interface device,
wherein the controller device via the interface device is configured to detect a UPC transmitted between the UPC reader and the POS device, block a UPC transmitted between the UPC reader and the POS device, and inject a UPC into the POS device, and
the POS device performs a POS function based on a received UPC from the controller device.

2. The system of claim 1, wherein the POS function includes reducing a transaction amount by a negative dollar amount associated with a UPC received from the controller device.

3. The system of claim 1, wherein the POS function includes issuing a reward based on a UPC received from the controller device.

4. The system of claim 1, wherein the POS function includes issuing an incentive based on a UPC received from the controller device.

5. The system of claim 1, wherein the UPC can include a bar code.

6. A computer implemented method for processing promotions, the method comprising:
coupling a universal product code (UPC) injection sub-system between a UPC reader device and a point-of-sale (POS) device;
coupling an interface device of the UPC injection sub-system between the UPC reader device and the POS device and incorporating an OR function to prevent disruption of an existing data stream between the POS device and the UPC reader device;
coupling a controller device of the UPC injection sub-system to the interface device;
detecting with the controller device via the interface device a UPC transmitted between the UPC reader and the POS device, blocking with the controller device via the interface device a UPC transmitted between the UPC reader and the POS device, and injecting with the controller device via the interface device a UPC into the POS device; and
performing a POS function with the POS device based on a received UPC from the controller device.

7. The method of claim 6, wherein the POS function includes reducing a transaction amount by a negative dollar amount associated with a UPC received from the controller device.

8. The method of claim 6, wherein the POS function includes issuing a reward based on a UPC received from the controller device.

9. The method of claim 6, wherein the POS function includes issuing an incentive based on a UPC received from the controller device.

10. The method of claim 6, wherein the UPC can include a bar code.

11. A computer program product for processing promotions, and including one or more computer readable instructions embedded on a tangible, non-transitory computer readable medium and configured to cause one or computer processors to perform the steps of:
coupling a universal product code (UPC) injection sub-system between a UPC reader device and a point-of-sale (POS) device;
coupling an interface device of the UPC injection sub-system between the UPC reader device and the POS device and incorporating an OR function to prevent disruption of an existing data stream between the POS device and the UPC reader device;
coupling a controller device of the UPC injection sub-system to the interface device;
detecting with the controller device via the interface device a UPC transmitted between the UPC reader and the POS device, blocking with the controller device via the interface device a UPC transmitted between the UPC reader and the POS device, and injecting with the controller device via the interface device a UPC into the POS device; and
performing a POS function with the POS device based on a received UPC from the controller device.

12. The computer program product of claim 11, wherein the POS function includes reducing a transaction amount by a negative dollar amount associated with a UPC received from the controller device.

13. The computer program product of claim 11, wherein the POS function includes issuing a reward based on a UPC received from the controller device.

14. The computer program product of claim 11, wherein the POS function includes issuing an incentive based on a UPC received from the controller device.

15. The computer program product of claim 11, wherein the UPC can include a bar code.
